(19) United States
(12) Patent Application Publication
(10) Pub. No.: US 2026/0332881 A1
(43) Pub. Date: Oct. 22, 2026

(54) INFORMATION PROCESSING DEVICE AND METHOD FOR CONTROLLING INFORMATION PROCESSING DEVICE

(71) Applicant: CANON KABUSHIKI KAISHA, Tokyo (JP)

(72) Inventor: YOSHIKAZU KAWAI, Tokyo (JP)

(21) Appl. No.: 19/529,380

(22) Filed: Feb. 4, 2026

(30) Foreign Application Priority Data
Feb. 13, 2025 (JP) 2025-021244

(51) Int. Cl. H04N 23/63; G06F 3/01; G06T 11/00; H04N 23/611; H04N 23/62

(52) U.S. Cl. CPC H04N 23/632; G06F 3/012; G06T 11/00; H04N 23/611; H04N 23/62; G06F 3/013

(57) ABSTRACT

An information processing device communicably connected to an imaging device according to the present disclosure includes one or more processors and/or circuitry configured to execute first acquisition processing to acquire a first image in which a space including the imaging device is captured from a point of view of a user, execute second acquisition processing to acquire a second image in which the space is captured with the imaging device, and execute generation processing to generate a composite image in which the first image and the second image are combined, wherein, in the generation processing, the composite image in which the second image is arranged so as not to overlap a region of the imaging device in the first image is generated in a case where the user holds the imaging device.

### BACKGROUND

### Field of the Technology

The present disclosure relates to an information processing device and a method for controlling an information processing device.

### Description of the Related Art

Virtual reality (VR) is known as a technology for enabling experience of virtual space. Furthermore, so-called mixed reality (MR) is known as a technology for seamlessly merging real space with virtual space in real time. Devices that enable experience of such technologies include head-mounted-type devices as represented by head-mounted displays (HMDs).

Japanese Patent Application Laid-open No. 2005-346468 describes a method for determining which of a virtual object and a real object is displayed when the virtual object overlaps the real object, on the basis of whether the distance between the position of a point of view and the position of the virtual object exceeds a preset threshold.

However, in Japanese Patent Application Laid-open No. 2005-346468, when a user wants to operate a button on an actual external imaging device, the button may be obscured by a virtual object such as a virtual window. In this case, the user has difficulty operating the button.

### SUMMARY

Therefore, the present disclosure provides a technology that facilitates physical operations, such as user's button pressing, while providing a virtual display.

The present disclosure its first aspect provides an information processing device communicably connected to an imaging device, including one or more processors and/or circuitry configured to first acquisition processing to acquire a first image in which a space including the imaging device is captured from a point of view of a user, execute second acquisition processing to acquire a second image in which the space is captured with the imaging device, and execute generation processing to generate a composite image in which the first image and the second image are combined, wherein, in the generation processing, the composite image in which the second image is arranged so as not to overlap a region of the imaging device in the first image is generated in a case where the user holds the imaging device.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of a system according to a first embodiment.

FIGS. 2A and 2B are external views of a camera according to the first embodiment.

FIG. 3 is an internal configuration diagram of the camera according to the first embodiment.

FIG. 4 is an internal configuration diagram of an HMD and the like according to the first embodiment.

FIG. 5 is a diagram illustrating an MR space according to the first embodiment.

FIG. 6 is a diagram illustrating an example of a display on the HMD according to the first embodiment.

FIG. 7 is a flowchart of live-view processing of the camera according to the first embodiment.

FIG. 8 is a flowchart of live-view processing of a PC according to the first embodiment.

FIG. 9 is a flowchart of UI display processing of the PC according to the first embodiment.

FIGS. 10A and 10B are diagrams illustrating a composite image according to the first embodiment.

FIGS. 11A and 11B are diagrams illustrating the composite image according to the first embodiment.

FIG. 12 is a flowchart of the UI display processing of the PC according to a second embodiment.

### DESCRIPTION OF THE EMBODIMENTS

Hereinafter, embodiments will be described in detail with reference to the accompanying drawings. Note that the following embodiments are not intended to limit the present disclosure. Although the embodiments describe a plurality of features, all of these features are not necessarily essential to the present disclosure, and the plurality of features may be combined arbitrarily. Moreover, in the accompanying drawings, the same reference numerals are assigned to the same or similar components, and redundant descriptions are omitted.

### FIRST EMBODIMENT

### Overall Configuration of System

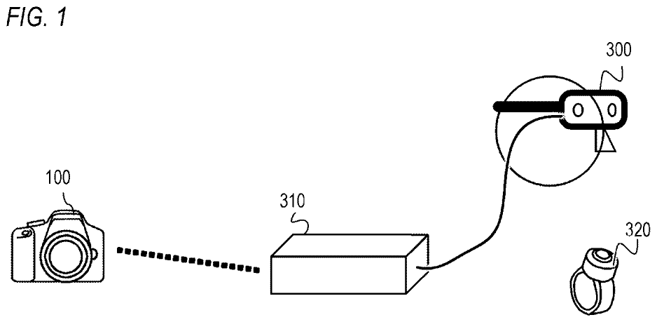

An example of the overall configuration of a system according to a first embodiment will be described with reference to FIG. 1. An information processing system 1 has a camera 100, an HMD 300, a personal computer (PC) 310, and a controller 320.

The camera 100 is connected to the PC 310 in a state capable of performing wired or wireless communication. The camera 100 transmits and receives various data (such as live-view image data or captured image data). Note that, instead of the camera 100, an imaging device (such as a smartphone or a tablet terminal) capable of implementing the functions described below may be, for example, used. Note that the camera 100 may perform communication not only with the PC 310 but also with the HMD 300.

Furthermore, the present embodiment illustrates an example of obtaining, as a final product, an image in which an image of a real space captured with the camera 100 and an object in a virtual space are combined. However, the technology according to the present embodiment can also be implemented when a user wearing the HMD 300 captures only an object in a real space with the camera 100. Therefore, neither an image displayed on the display of the HMD 300 nor a final product necessarily includes a virtual object as a subject.

The HMD 300 is a display device (head-mounted-type electronic equipment) that can be worn on the user's head. The HMD 300 displays a composite image in which an “image of an area in front of the user captured with the HMD 300” and “content such as CG in a form corresponding to the position and posture of the HMD 300” are combined.

The PC 310 is an information processing device that controls the HMD 300. The PC 310 is connected to the HMD 300 either via a wired connection, such as a USB cable, or via a wireless connection, such as Bluetooth™ or Wi-Fi (Wireless Fidelity)™. For example, the PC 310 generates a composite image by combining a captured image with CG and transmits the composite image to the HMD 300. In this case, when receiving a live-view image or a captured image from the camera 100, the PC 310 generates a composite image in which the received image and CG in a form corresponding to the position and posture of the camera 100 are combined. The PC 310 then transmits the composite image to the HMD 300.

Note that a smartphone or a tablet terminal may be used instead of the PC 310. Furthermore, each component of the PC 310 may be included in the HMD 300. Note that in the first embodiment, an example is shown in which the PC 310 and the camera 100 are connected via a wireless connection, but they may also be connected via a wired connection.

The controller 320 performs various types of control on the HMD 300. When the PC 310 is in a specific control mode, the HMD 300 is controlled in response to a user's operation on the controller 320. As illustrated in FIG. 1, the controller 320 is an operation member having either a “ring-like shape, which can be worn on and supported by the user's finger,” or a “hand-held shape”. Furthermore, the controller 320 has a physical button for performing determination and selection operations on the display.

The controller 320 performs wireless communication with the PC 310 via Bluetooth. Note that the controller 320 may perform communication not only with the PC 310 but also with the HMD 300. By operating the controller 320, the user can change an instructing position on the display in accordance with the movement of the controller 320. The instructing position may be represented either as a point or as a virtual ray that connects the point of the instructing position and the controller by a straight line (line segment) or a dotted line. The user can perform determination and selection operations on a menu by pressing a physical button.

Note that the shape of the controller 320 is either a ring type or a hand-held type. However, the controller 320 may have any shape as long as it can be supported by a finger, a hand, or an arm. Furthermore, although the button of the controller 320 is a physical button, it may be any operable type, such as a trackpad, a touch panel, a wheel, or a track ball. Furthermore, the controller 320 may also be capable of receiving sliding, flicking, or touch operations in addition to a button pressing operation. Note that the controller 320 may be worn on at least one of a finger, a hand, or an arm. Note that the controller 320 may also be attached to an object gripped by the hand, and the position and posture information of the attached position may be acquired from a sensor. Examples of such an object include an object imitating a tool.

### External Configuration of Digital Camera

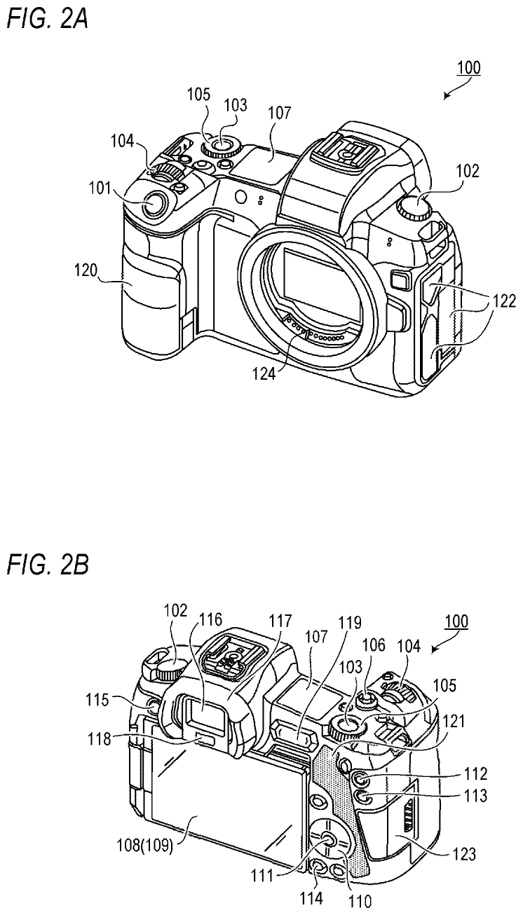

FIGS. 2A and 2B are views illustrating an example of the external configuration of the camera 100 that serves as an imaging device. FIG. 2A is a perspective view of the camera 100 when viewed from the front surface. FIG. 2B is a perspective view of the camera 100 when viewed from the back surface.

The camera 100 has a shutter button 101, a power switch 102, a mode selection switch 103, a main electronic dial 104, a sub-electronic dial 105, a moving-image button 106, and a display unit 107 outside a viewfinder.

The shutter button 101 is an operation unit used to provide capture-preparation instructions or capture instructions. The power switch 102 is an operation unit used to switch the power of the camera 100 on or off. The mode selection switch 103 is an operation unit used to select various modes.

The main electronic dial 104 is a rotary operation unit used to change setting values, such as the shutter speed and aperture. The sub-electronic dial 105 is a rotary operation unit used to perform movement of a selected frame (cursor), image feeding, and the like.

The moving-image button 106 is an operation unit used to provide instructions to start or stop capturing (recording) moving images. The display unit 107 outside the viewfinder displays various setting values, such as the shutter speed or aperture.

Furthermore, the camera 100 has, on its rear surface, a display unit 108, a touch panel 109, a direction key 110, a SET button 111, an AE lock button 112, an enlargement button 113, a reproduction button 114, a menu button 115, an eyepiece unit 116, an eyepiece detection unit 118, and a touch bar 119.

The display unit 108 displays images and various information. The touch panel 109 is an operation unit used to detect touch operations on the display surface (touch operation surface) of the display unit 108.

The direction key 110 is an operation unit composed of a key (four-direction key) that can be pressed in both the vertical and horizontal directions. It is possible to control the camera 100 on the basis of the position pressed on the direction key 110. The SET button 111 is an operation unit pressed mainly to determine a selected item.

The AE lock button 112 is an operation unit pressed to hold an exposed state while the camera 100 is in a capture standby state.

The enlargement button 113 is an operation unit used to switch the enlargement mode on or off in the live-view display (LV display) of a capture mode. When the enlargement mode is turned on, a live-view image (LV image) is enlarged or reduced in accordance with the operation of the main electronic dial 104. Furthermore, the enlargement button 113 is used to enlarge a reproduction image or increase a magnification ratio in a reproduction mode.

The reproduction button 114 is an operation unit used to switch between the capture mode and the reproduction mode. When the reproduction button 114 is pressed during the capture mode, the camera 100 transitions to the reproduction mode, and the display unit 108 displays the latest image among those recorded on a recording medium 227.

The menu button 115 is an operation unit pressed to display a menu screen on the display unit 108, where various settings are possible. The user can intuitively perform various settings using the menu screen displayed on the display unit 108, the direction key 110, and the SET button 111.

The eyepiece unit 116 is a portion into which the user brings their eye close to (or in contact with) the eyepiece finder 117. Through the eyepiece unit 116, the user can visually recognize the image displayed on an electronic viewfinder (EVF) 217.

The eyepiece detection unit 118 is a sensor (eyepiece sensor) used to detect whether the user's eye is in contact with the eyepiece unit 116.

The touch bar 119 is a linear touch-operation unit (line touch sensor) capable of receiving touch operations. The touch bar 119 is arranged at a “touchable position where the user is able to perform touch operations with the thumb of the right hand while holding a grip unit 120 with the right hand (i.e., while holding the grip unit 120 with the little finger, the ring finger, and the middle finger of the right hand)” so that the shutter button 101 can be pressed with the index finger of the right hand. In other words, the touch bar 119 is operable while the user brings their eye in contact with the eyepiece unit 116 to look through the eyepiece finder 117 and holds the camera 100 up (in a capturing posture) that enables pressing of the shutter button 101 at any time. The touch bar 119 is capable of receiving operations, such as tapping (touching and releasing without moving within a prescribed period after touching) and sliding (moving the touched position while maintaining contact after touching) in the left-and-right direction. The touch bar 119 is an operation unit different from the touch panel 109 and does not include a display function. The touch bar 119 is a multi-function bar and functions, for example, as an M-Fn bar.

Furthermore, the camera 100 also has a grip unit 120, a thumb-rest unit 121, a terminal cover 122, a lid 123, a communication terminal 124, and the like.

The grip unit 120 is a holding unit formed into a shape easily gripped by the right hand when the user holds the camera 100 up. The shutter button 101 and the main electronic dial 104 are arranged at positions where the user is able to perform operations with the index finger of the right hand while holding the camera 100 with the grip unit 120 gripped by the little finger, the ring finger, and the middle finger of the right hand. Furthermore, in the same state, the sub-electronic dial 105 and the touch bar 119 are arranged at positions where the user is able to perform operations with the thumb of the right hand.

The thumb-rest unit 121 (thumb standby position) is a grip unit provided on the rear-surface side of the camera 100, at a position where the user can easily place the thumb of the right hand gripping the grip unit 120 when not operating any other operation unit. The thumb-rest unit 121 is composed of a rubber member or the like used to enhance the holding force (grip feel).

The terminal cover 122 protects a connector such as a connection cable that connects the camera 100 to external equipment. The lid 123 closes a slot where the recording medium 227 is stored, thereby protecting both the recording medium 227 and the slot.

The communication terminal 124 is a terminal used to perform communication with a lens unit 200.

### Internal Configuration of Digital Camera

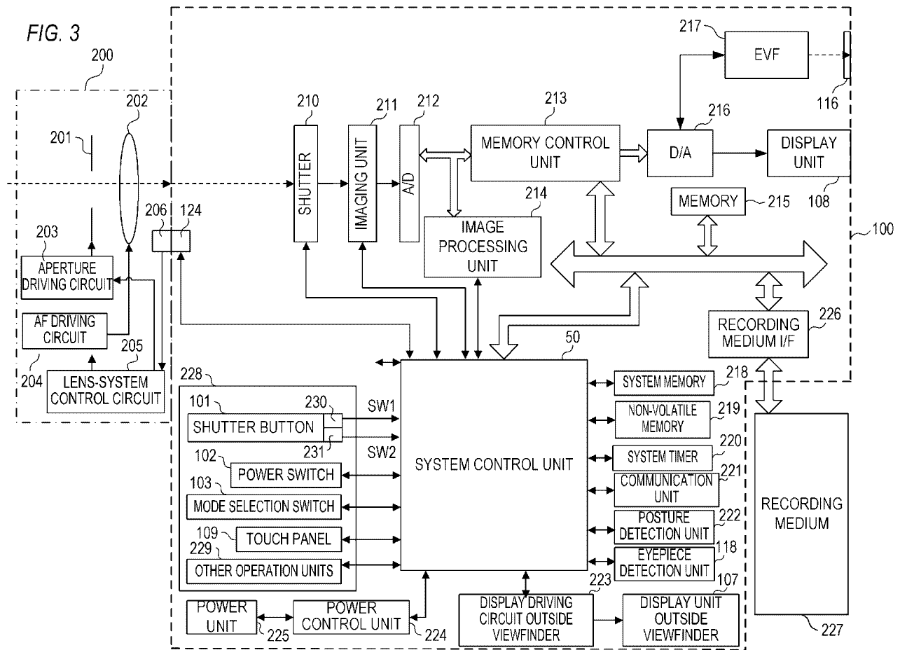

FIG. 3 is a block diagram illustrating an example of the internal configuration of the camera 100. Note that in FIG. 3, components that are the same as those in FIGS. 2A and 2B are assigned the same reference numerals, and their description are omitted as appropriate. The lens unit 200 is attached to the camera 100.

First, the lens unit 200 will be described. The lens unit 200 is a type of an interchangeable lens attachable to and detachable from the camera 100. The lens unit 200 is a single-lens unit (monocular lens) and illustrates an example of a normal lens. The lens unit 200 has an aperture 201, a lens 202, an aperture driving circuit 203, an auto focus (AF) driving circuit 204, a lens-system control circuit 205, a communication terminal 206, and the like.

The aperture 201 has an adjustable aperture diameter. The lens 202 is composed of a plurality of lenses. The aperture driving circuit 203 adjusts the amount of light by controlling the diameter of the aperture 201. The AF driving circuit 204 drives the lens 202 to achieve focus.

The lens-system control circuit 205 controls the aperture driving circuit 203, the AF driving circuit 204, and the like on the basis of instructions from a system control unit 50. The lens-system control circuit 205 controls the aperture 201 via the aperture driving circuit 203. The lens-system control circuit 205 achieves focus by adjusting the position of the lens 202 via the AF driving circuit 204. The lens-system control circuit 205 is capable of performing communication with the camera 100. Specifically, communication is performed via the communication terminal 206 of the lens unit 200 and the communication terminal 124 of the camera 100. The communication terminal 206 is a terminal used when the lens unit 200 performs communication with the camera 100.

Next, the camera 100 will be described. The camera 100 has a shutter 210, an imaging unit 211, an A/D converter 212, a memory control unit 213, an image processing unit 214, a memory 215, a D/A converter 216, an EVF 217, a display unit 108, and a system control unit 50.

The shutter 210 is a focal-plane shutter capable of freely controlling the exposure time of the imaging unit 211 on the basis of instructions from the system control unit 50.

The imaging unit 211 is an imaging element (image sensor) composed of a CCD element, a CMOS element, or the like that converts optical images into electric signals. The imaging unit 211 may have an imaging-plane phase difference sensor that outputs defocus-amount information to the system control unit 50.

The A/D converter 212 converts analog signals output from the imaging unit 211 into digital signals.

The image processing unit 214 performs prescribed processing (such as resize processing including pixel interpolation and contraction or color conversion processing) on data from the A/D converter 212 or data from the memory control unit 213. Furthermore, the image processing unit 214 performs prescribed computational processing using data from captured images. The system control unit 50 performs exposure control or ranging control on the basis of the obtained computation results. By this processing, a through-the-lens (TTL) AF processing, automatic exposure (AE) processing, electronic flash pre-emission (EF) processing, and the like are performed. Moreover, the image processing unit 214 performs prescribed computational processing using data from captured images and performs automatic white balance (AWB) processing of a TTL system on the basis of the obtained computation results. The image data from the A/D converter 212 is written into the memory 215 via the image processing unit 214 and the memory control unit 213. Alternatively, the image data from the A/D converter 212 is written into the memory 215 via the memory control unit 213 without being subjected to the image processing unit 214.

The memory 215 stores the “image data acquired with the imaging unit 211 and converted into digital data by the A/D converter 212” and the “image data that is to be displayed on the display unit 108 or the EVF 217.” The memory 215 includes sufficient storage capacity to store a prescribed number of still images or moving images and sounds for a prescribed period of time. Furthermore, the memory 215 also serves as a memory (video memory) for displaying images.

The D/A converter 216 converts the image data for display stored in the memory 215 into analog signals and supplies the converted signals to the display unit 108 and the EVF 217. Accordingly, the image data for display written into the memory 215 is displayed on the display unit 108 or the EVF 217 via the D/A converter 216. The display unit 108 and the EVF 217 display images according to the analog signals from the D/A converter 216. The display unit 108 and the EVF 217 are, for example, LCDs or organic EL displays. Digital signals A/D-converted by the A/D converter 212 and stored in the memory 215 are converted into analog signals by the D/A converter 216. The analog signals are sequentially transferred to the display unit 108 and the EVF 217, thereby performing live-view display of images representing a real-time scene.

The system control unit 50 is a control unit including at least one processor and/or at least one circuit. In other words, the system control unit 50 may be a processor, a circuit, or a combination thereof. The system control unit 50 controls the entire camera 100. The system control unit 50 implements each process of the flowcharts described later by executing a program recorded on a non-volatile memory 219. Furthermore, the system control unit 50 also performs display control by controlling the memory 215, the D/A converter 216, the display unit 108, the EVF 217, and the like.

Furthermore, the camera 100 has a system memory 218, the non-volatile memory 219, a system timer 220, a communication unit 221, a posture detection unit 222, and an eyepiece detection unit 118.

As the system memory 218, a RAM is, for example, used. The system memory 218 stores a “constant for operating the system control unit 50,” a “variable,” a “program read from the non-volatile memory 219,” and the like.

The non-volatile memory 219 is an electrically erasable and recordable memory. An EEPROM is, for example, used as the non-volatile memory 219. The non-volatile memory 219 stores a constant for operating the system control unit 50, a program, and the like. Here, the program refers to a program for executing the flowcharts described later.

The system timer 220 is a clocking unit that measures the time used in various control processes and the time of the internal clock. The communication unit 221 performs transmission and reception of video signals or audio signals with external equipment connected via a wireless or wired cable.

The communication unit 221 can also connect to a wireless local area network (LAN) or the Internet. Furthermore, the communication unit 221 can communicate with external equipment via Bluetooth™ or Bluetooth Low Energy. The communication unit 221 can transmit images (including live-view images) captured with the imaging unit 211 or images recorded on the recording medium 227. Furthermore, the communication unit 221 can receive images and various other information from the external equipment.

The posture detection unit 222 detects the posture of the camera 100 in the gravity direction. On the basis of the posture detected by the posture detection unit 222, it is possible to discriminate “whether an image captured with the imaging unit 211 was captured in a state in which the camera 100 was held in a horizontal orientation or a vertical orientation.” The system control unit 50 can add orientation information corresponding to the posture detected by the posture detection unit 222 to the image files of the images captured with the imaging unit 211, or can also rotate and record the images. As the posture detection unit 222, an acceleration sensor, a gyro sensor, or the like can, for example, be used. It is also possible to detect the movement (pan, tilt, lifting, standing-still, or the like) of the camera 100 using the posture detection unit 222.

The eyepiece detection unit 118 can detect the approach of any object toward the eyepiece unit 116 of the eyepiece finder 117, which includes the EVF 217. As the eyepiece detection unit 118, an infrared proximity sensor can, for example, be used. When an object approaches the eyepiece unit 116, infrared light projected from the projection unit of the eyepiece detection unit 118 is reflected at the object and received by the light-receiving unit of the infrared proximity sensor. On the basis of the amount (sensor value) of the received infrared light, it is possible to discriminate the distance from the eyepiece unit 116 to the object. As described above, the eyepiece detection unit 118 performs eyepiece detection to detect the proximity distance of an object to the eyepiece unit 116. The eyepiece detection unit 118 is an eyepiece detection sensor that detects the approach (contact) and regression (separation) of an eye (object) relative to the eyepiece unit 116 of the eyepiece finder 117. When an object approaching the eyepiece unit 116 within a prescribed distance is detected from a non-contacting state (non-approaching state), the eyepiece detection unit 118 detects the contact of the object. On the other hand, when an object that has approached the eyepiece unit 116 is separated by at least a prescribed distance from a contacting state (approaching state), the eyepiece detection unit 118 detects the separation of the object. A threshold for detecting contact and a threshold for detecting separation may differ from each other, for example, by setting hysteresis or the like. Furthermore, after the detection of contact, it is assumed that the contacting state is maintained until separation is detected. After the detection of separation, it is assumed that the non-contacting state is maintained until contact is detected.

The system control unit 50 switches between the display (display state) and non-display (non-display state) of the display unit 108 and the EVF 217 on the basis of the state detected by the eyepiece detection unit 118. Specifically, when the camera 100 is in at least a capture standby state and its display destination setting is set to automatic switching, the system control unit 50 brings the display unit 108 into a display state as the display destination and the EVF 217 into a hidden state when the eye is not in contact. Furthermore, the system control unit 50 brings the EVF 217 into a display state as the display destination and the display unit 108 into a hidden state when the eye is in contact. Note that the eyepiece detection unit 118 is not limited to an infrared proximity sensor. Any sensor that is capable of detecting a state considered as contact may be used as the eyepiece detection unit 118.

Furthermore, the camera 100 has the display unit 107 outside the viewfinder, a display driving circuit 223 outside the viewfinder, a power control unit 224, a power unit 225, a recording medium I/F 226, an operation unit 228, and the like.

The display unit 107 displays various setting values (such as the shutter speed or aperture) of the camera 100 via the display driving circuit 223 outside the viewfinder.

The power control unit 224 is composed of a battery detection circuit, a DC-DC converter, a switch circuit that switches blocks to be energized, and the like. The power control unit 224 detects the presence or absence of a battery, the type of a battery, the remaining battery level, and the like. Furthermore, the power control unit 224 controls the DC-DC converter on the basis of the detection results and instructions from the system control unit 50 and supplies a voltage to each unit (including the recording medium 227) for a required period.

The power unit 225 includes a primary battery (such as an alkaline battery or a lithium battery), a secondary battery (such as an NiCd battery, an NiMH battery, or an Li battery), an AC adapter, and the like.

The recording medium I/F 226 is an interface with the recording medium 227. The recording medium 227 is a memory card or the like for recording captured images. The recording medium 227 includes a semiconductor memory, a magnetic disk, or the like.

The recording medium 227 may be attachable to and detachable from the camera 100, or it may be built into the camera 100.

The operation unit 228 is an input unit that receives operations (user operations) from the user. The operation unit 228 is used to input various instructions to the system control unit 50. The operation unit 228 includes the shutter button 101, the power switch 102, the mode selection switch 103, the touch panel 109, other operation units 229, and the like.

The operation units 229 include the main electronic dial 104, the sub-electronic dial 105, the moving-image button 106, the direction key 110, the SET button 111, the AE lock button 112, the enlargement button 113, the reproduction button 114, the menu button 115, the touch bar 119, and the like.

The shutter button 101 has a first shutter switch 230 and a second shutter switch 231.

The first shutter switch 230 turns on when the shutter button 101 is pressed halfway, i.e., half-press (capture preparation instruction), and outputs a first shutter switch signal SW1. The system control unit 50 starts capture preparation processing (such as AF processing, AE processing, AWB processing, or EF processing) on the basis of the first shutter switch signal SW1.

The second shutter switch 231 turns on when the shutter button 101 is fully pressed, i.e., full-press (capture instruction), and outputs a second shutter switch signal SW2. The system control unit 50 starts a series of capture processing (from reading a signal from the imaging unit 211 to generating an image file including the captured image and writing the image file into the recording medium 227) on the basis of the second shutter switch signal SW2.

The mode selection switch 103 switches the operation mode of the system control unit 50 to any of a still-image capturing mode, a moving-image capturing mode, a reproduction mode, or the like. The still-image capturing mode includes an automatic capturing mode, an automatic scene determination mode, a manual mode, an aperture-priority mode (Av mode), a shutter-speed-priority mode (Tv mode), a program AE mode (P mode), and the like. Furthermore, the still-image capturing mode also includes various scene modes, custom modes, and the like that represent settings corresponding to different capturing scenes. Through the mode selection switch 103, the user can directly switch the operation mode to any of the capturing modes described above. Alternatively, after temporarily switching to a list screen of the capturing modes through the mode selection switch 103, the user can selectively switch to any of the displayed modes using the operation unit 228. Similarly, the moving-image capturing mode may also include a plurality of modes.

The touch panel 109 is a touch sensor that detects various touch operations on the display surface of the display unit 108 (the operation surface of the touch panel 109). The touch panel 109 and the display unit 108 can be integrally configured. For example, the touch panel 109 is attached to the upper layer of the display surface of the display unit 108 so that the light transmission does not interfere with the display of the display unit 108. Furthermore, by associating input coordinates in the touch panel 109 with display coordinates on the display surface of the display unit 108, it is possible to configure a graphical user interface (GUI) that enables the user to feel as if he/she were directly operating a screen displayed on the display unit 108. The touch panel 109 can employ any of various systems, such as a resistance-film system, a capacitive system, a surface acoustic wave system, an infrared system, an electromagnetic induction system, an image recognition system, and an optical sensor system. Depending on the system, some types detect a touch operation when the touch panel 109 is touched, while other types detect a touch operation when a finger or a pen approaches the touch panel 109. However, any of these types may be employed.

The system control unit 50 can detect the following operations or states on the touch panel 109.
*A state in which a finger or a pen that was not touching the touch panel 109 newly touches the touch panel 109, i.e., the start of a touch (hereinafter referred to as touch-down).
*A state in which the touch panel 109 is being touched by a finger or a pen (hereinafter referred to as touch-on).
*A state in which a finger or a pen moves while touching the touch panel 109 (hereinafter referred to as touch-move).
*A state in which a finger or a pen that was touching the touch panel 109 is separated (released) from the touch panel 109, i.e., the end of a touch (hereinafter referred to as touch-up).
*A State in Which the Touch Panel 109 Is Not Being Touched (hereinafter Referred to As touch-off).

The touch-on is detected simultaneously with the detection of the touch-down. Generally, the touch-on is continuously detected unless the touch-up is detected after the touch-down. The touch-on is detected simultaneously with the detection of the touch-move. Even if the touch-on is being detected, the touch-move is not detected unless a touch position moves. After the touch-up of all touched fingers or a pen is detected, the touch-off is detected.

Via an internal bus, the system control unit 50 is notified of these operations and states, as well as the position coordinates at which a finger or a pen is touching the touch panel 109. On the basis of the notified information, the system control unit 50 determines what operation (touch operation) was performed on the touch panel 109. For the touch-move, the system control unit 50 can also determine the movement direction of a finger or a pen moving on the touch panel 109 for each vertical and horizontal component on the touch panel 109, on the basis of changes in the position coordinates. When the touch-move of at least a prescribed distance is detected, the system control unit 50 determines that a slide operation was performed. The operation of quickly moving a finger by a certain distance while touching the touch panel 109 and then releasing it is referred to as a flick. In other words, the flick is an operation in which the user quickly traces the touch panel 109 so as to flip it with a finger. The system control unit 50 determines that a flick was performed when it detects the touch-move of at least a prescribed distance and at least at a prescribed speed, followed immediately by the touch-up (i.e., the flick was performed in succession to the slide operation). Moreover, a touch operation in which a plurality of spots (for example, two points) (multi-touch) are simultaneously touched and the touched positions are brought closer together is referred to as pinch-in, while a touch operation in which the touched positions are moved away from each other is referred to as pinch-out. Such pinch-in and pinch-out operations are collectively referred to as a pinch operation (or simply a pinch).

### Configuration of HMD

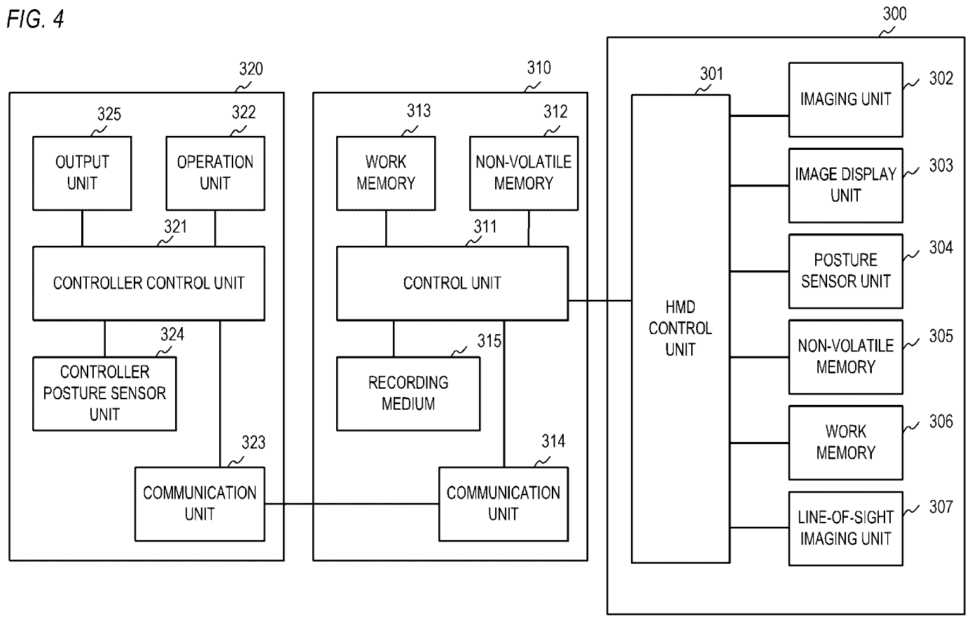

An example of the configuration of the HMD 300 will be described with reference to FIG. 4. The HMD 300 has an HMD control unit 301, an imaging unit 302, an image display unit 303, a posture sensor unit 304, a non-volatile memory 305, a work memory 306, and a line-of-sight imaging unit 307.

The HMD control unit 301 is a CPU that controls each component of the HMD 300. When the HMD control unit 301 acquires a composite image (i.e., an image in which CG and an image of a space in front of the user captured with the imaging unit 302 are combined) from the PC 310, it displays the composite image on the image display unit 303. Note that, instead of the HMD control unit 301 controlling each component, a plurality of hardware units may share processing to control the entire device.

The imaging unit 302 includes two cameras (imaging devices). The two cameras capture images that are used for combining with an image of a virtual space and for generating position and posture information. The two cameras include a left-eye imaging unit and a right-eye imaging unit. The left-eye imaging unit captures a moving image of a real space corresponding to the wearer's left eye of the HMD 300. The left-eye imaging unit outputs an image (captured image) of each frame in the moving image. The right-eye imaging unit captures a moving image of a real space corresponding to the wearer's right eye of the HMD 300. The right-eye imaging unit outputs an image (captured image) of each frame in the moving image. That is, the imaging unit 302 acquires captured images as stereo images with a parallax that approximately matches the positions of the wearer's left and right eyes of the HMD 300. Furthermore, by performing ranging with the stereo cameras, the distance from the two cameras to a subject can be acquired as distance information. Note that, in an HMD for MR systems, it is preferable that the central optical axis of the imaging range of the imaging unit be approximately aligned with the line-of-sight direction of the HMD wearer.

Each of the left-eye imaging unit and the right-eye imaging unit includes an optical system and an imaging device. Light entering from the outside is incident on the imaging devices through the optical systems, and the imaging devices output images corresponding to the incident light as captured images. The images obtained when the two cameras capture a subject (i.e., an area in front of the user) are output to both the PC 310 and the HMD control unit 301. Note that the imaging unit 302 may output video instead of the captured images.

The image display unit 303 displays a composite image. The image display unit 303 has a liquid-crystal panel, an organic EL panel, or the like. When the user wears the HMD 300, the image display unit 303 is located in front of each of the user's eyes. Note that the image display unit 303 may also use a device with a semi-transparent half mirror. In this case, the image display unit 303 may display an image such that CG appears directly superimposed on the real space seen through the half mirror, according to, for example, a technology generally referred to as augmented reality (AR). Furthermore, the image display unit 303 may also display a full virtual-space image without using a captured image, according to a technology generally referred to as virtual reality (VR).

The posture sensor unit 304 acquires the posture (and position) information of the HMD 300. Note that the posture sensor unit 304 may alternatively acquire the posture information of the user (i.e., the user wearing the HMD 300) corresponding to the posture (and position) of the HMD 300. The posture sensor unit 304 has, for example, an inertial measurement unit (IMU) composed of an acceleration sensor, an angular acceleration sensor, and a geomagnetic sensor. The posture sensor unit 304 is used to acquire user's posture information (posture information), and the HMD control unit 301 outputs this information to the PC 310. Note that the posture information may also be acquired from at least one of a magnetic sensor (including a geomagnetic sensor), an ultrasonic sensor, an acceleration sensor, or an angular velocity sensor.

The HMD control unit 301 estimates the positions and postures of the user's hand and the joint points of the fingers on the basis of the images captured with the two cameras of the imaging unit 302. Note that these joint points include feature points of parts such as finger joints, fingertips, the back (or palm) of the hand, and the arms. Each joint point indicates a coordinate position. The posture of the hand can be estimated on the basis of the information of the plurality of joint points. As a method for estimating the positions and postures of the hand and its joint points, known object recognition or pose estimation based on machine learning using convolutional neural networks can be, for example, employed. Furthermore, the position information of each joint point of the hand in the depth direction can be obtained by calculating the distance from the imaging unit 302 to each joint point, for example, by triangulation based on stereo matching using images captured with the two cameras of the imaging unit 302. The estimated coordinate information of each joint point of the hand is output from the HMD control unit 301 to the PC 310. The HMD control unit 301 may detect the position of the camera 100 on the basis of the images captured with the two cameras of the imaging unit 302. The HMD control unit 301 may acquire the posture information obtained by the posture detection unit 222 within the camera 100 as the posture information of the camera 100.

The non-volatile memory 305 is an electrically erasable and recordable non-volatile memory. The non-volatile memory 305 stores, for example, the program described below, which is executed by the control unit 311.

The work memory 306 is used as a buffer memory that temporarily stores the image data captured with the imaging unit 302, an image display memory for the image display unit 303, a work area for the HMD control unit 301, or the like.

The line-of-sight imaging unit 307 is a camera that acquires images for detecting the user's line of sight. The line-of-sight imaging unit 307 is attached to the inner side of the HMD 300 to capture images of the user's eyes when the HMD 300 is worn. The images of the subject (user's eyes) captured with the camera are output to the control unit 311 of the PC 310 through the HMD control unit 301. The control unit 311 detects the line of sight of the user wearing the HMD 300 from the images captured with the line-of-sight imaging unit 307 and identifies the location on the image display unit 303 at which the user is gazing.

### Internal Configuration of PC

The internal configuration of the PC 310 will be described with reference to FIG. 4. The PC 310 has a control unit 311, a non-volatile memory 312, a work memory 313, a communication unit 314, and a recording medium 315.

The control unit 311 is a CPU that controls each unit of the PC 310 in accordance with input signals and the program described below. Note that, instead of the control unit 311 controlling the entire PC 310, a plurality of hardware units may share processing to control the PC 310 as a whole. The control unit 311 receives, from the HMD 300, the images (captured images) acquired with the imaging unit 302 and the posture information acquired with the posture sensor unit 304. The control unit 311 performs image processing on the captured images to cancel aberrations between the optical system of the imaging unit 302 and the optical system of the image display unit 303. The control unit 311 then combines the captured images with arbitrary CG to generate a composite image. The control unit 311 transmits the composite image to the HMD control unit 301 in the HMD 300.

Furthermore, the control unit 311 determines the number of the controllers 320 included in the captured images. The control unit 311 also executes processing, using information obtained through the communication unit 314, to recognize a position where each of the controllers 320 is attached. The control unit 311 performs control to change operation content for input information of each of the controllers 320 according to the recognition result.

Note that the control unit 311 controls the position, orientation, and size of CG in a composite image on the basis of information (distance information and posture information) acquired with the HMD 300. For example, when arranging a virtual object represented by CG near a specific object present in a real space within the space expressed by a composite image, the control unit 311 enlarges the virtual object (CG) if the distance between the specific object and the imaging unit 302 is smaller. By controlling the position, orientation, and size of CG in this manner, the control unit 311 can generate a composite image in which a CG object is not present in a real space appears as if it were present in the real space.

Furthermore, the control unit 311 receives information (i.e., coordinate information of each joint point of the hand) estimated by the HMD control unit 301 of the HMD 300. The received information is temporarily stored in the work memory 313.

Furthermore, the control unit 311 receives information on changes in the position or posture of the controller 320 from a communication unit 323 of the controller 320. The control unit 311 superimpose a display item indicating a position corresponding to changes in the position or posture of the controller 320 on a composite image. Note that the control unit 311 may superimpose a display item indicating a position corresponding to changes in the position and posture of the controller 320 on a composite image.

The non-volatile memory 312 is an electrically erasable and recordable non-volatile memory. The non-volatile memory 312 stores the program described below, which is executed by the control unit 311, as well as information such as CG. Note that the control unit 311 can switch between CG read from the non-volatile memory 312 (i.e., CG used to generate a composite image).

The work memory 313 is used as a buffer memory that temporarily stores the image data captured with the imaging unit 302 and time-series information of estimated coordinate positions of each joint point of the hand. Furthermore, the work memory 313 is used as an image display memory for the image display unit 303, a work area for the control unit 311, or the like.

Furthermore, the estimation of the hand joints may also be performed by the PC 310. In this case, after the captured images are output from the imaging unit 302 to the PC 310, the control unit 311 of the PC 310 estimates the position or posture of each joint point of the hand. The control unit 311 then performs image processing using this information and outputs the processed image to the HMD 300. Note that the control unit 311 may estimate the position and posture of each joint point of the hand, perform image processing using this information, and output the processed image to the HMD 300.

### Internal Configuration of Controller

The internal configuration of the controller 320 will be described with reference to FIG. 4. The controller 320 has a controller control unit 321, an operation unit 322, a communication unit 323, a controller posture sensor unit 324, and an output unit 325.

The controller control unit 321 is a CPU that controls each component of the controller 320. Note that, instead of the controller control unit 321 controlling the entire controller 320, a plurality of hardware units may share processing to control the controller 320 as a whole.

The operation unit 322 includes a button. The operation unit 322 detects whether the button has been operated and transmits detection information to the PC 310 through the communication unit 323. Note that the operation unit 322 may have a plurality of types of input formats.

The communication unit 323 performs wireless communication with the PC 310 via Bluetooth. When a plurality of controllers 320 are connected to the PC 310, each communication unit 323 of the controllers 320 performs wireless communication with the PC 310 via Bluetooth.

The controller posture sensor unit 324 has an inertial measurement unit (IMU) composed of an acceleration sensor, an angular acceleration sensor, and a geomagnetic sensor. The inertial measuring unit detects changes in the position or posture of the controller 320. The detected Information on the changes in the position and posture is transmitted from the communication unit 323 to the PC 310 through the controller control unit 321.

The output unit 325 is composed of an LED light source, a speaker, a vibration element, and the like.

### Example of MR Space

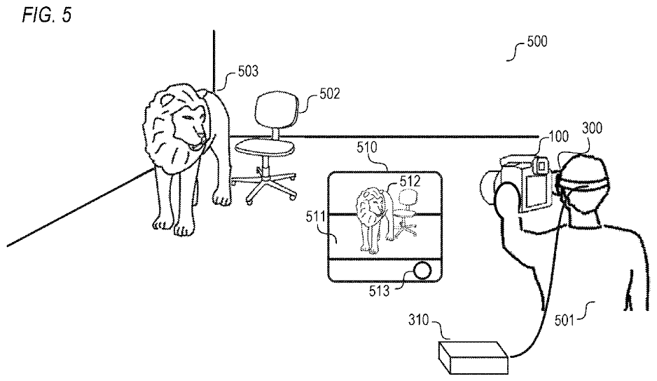

With reference to FIG. 5, an example of an MR space experienced by a user wearing the HMD 300 according to the first embodiment will be described. In the MR space 500, the user 501, the HMD 300 worn by the user 501, the PC 310 communicating with the HMD 300, and the camera 100 communicating with the PC 310 are present. Furthermore, in the MR space 500, a real object 502, a virtual object 503, and a virtual window 510 are present.

The virtual window 510 is an example of a UI for a capturing application. In the virtual window 510, a live-view image 511, a virtual object 512, and an operation member 513 are displayed. The live-view image 511 is an image captured with the imaging unit 211 of the camera 100. The virtual object 512 is a virtual object having a form corresponding to the position and posture of the camera 100.

### Example of Screen Display of HMD 300

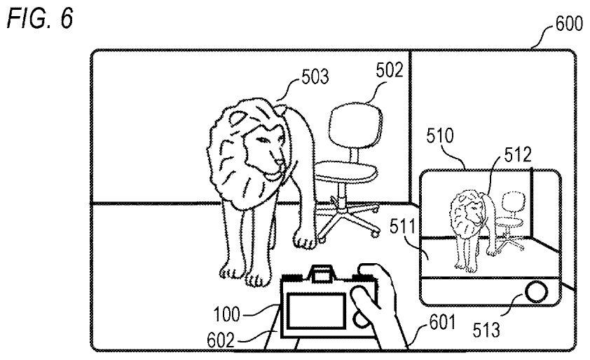

With reference to FIG. 6, an example of a display on the image display unit 303 of the HMD 300 will be described. A screen 600 in FIG. 6 illustrates an example of the display on the image display unit 303 when the imaging unit 302 of the HMD 300 worn by the user 501 captures an image of an MR space.

On the screen 600, the real object 502, the virtual object 503, and the virtual window 510 are displayed. Furthermore, in the virtual window 510, the live-view image 511, the virtual object 512, and the operation member 513 are displayed. Furthermore, on the screen 600, a user's right hand 601 (i.e., the hand gripping (holding) the camera 100) and a left hand 602 (i.e., the hand gripping the lens not illustrated) are displayed.

Note that, as illustrated in the MR space 500 in FIG. 5, an example in which the virtual window 510 is arranged as if it were virtually present at any three-dimensional position and with any posture in a space will be described, but the present disclosure is not limited to this. The virtual window 510 may be arranged at a two-dimensional position within the display region of the screen 600.

### Live-View Processing of Camera 100

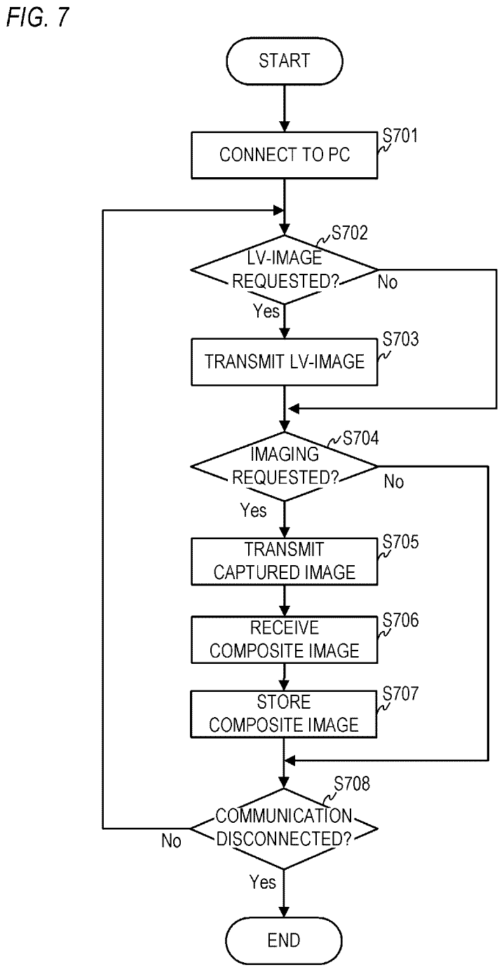

With reference to the flowchart of FIG. 7, the processing of the camera 100 according to the first embodiment will be described.

In step S701, the system control unit 50 controls the communication unit 221 to connect to the PC 310 so that communication with the PC 310 becomes possible. A method for connecting to the PC 310 is not limited. The connection to the PC 310 may be implemented either via wireless communication or via wired communication.

In step S702, the system control unit 50 determines whether acquisition of a live-view image (LV image; real-time image) has been requested from the PC 310. When it is determined that the acquisition of a live-view image has been requested, the processing proceeds to step S703. When it is determined that the acquisition of a live-view image has not been requested, the processing proceeds to step S704.

In step S703, the system control unit 50 transmits the live-view image (live-view information) to the PC 310 in response to the request for acquiring the live-view image. Furthermore, the system control unit 50 transmits lens optical information in addition to the live-view image information.

In step S704, the system control unit 50 determines whether imaging has been requested (i.e., imaging has been requested from the PC 310 or by the user operating the camera 100). When it is determined that imaging has been requested, the processing proceeds to step S705. When it is determined that imaging has not been requested, the processing proceeds to step S708.

In step S705, the system control unit 50 executes imaging processing. The system control unit 50 transmits the image (captured image) acquired through the imaging processing to the HMD 300.

In step S706, the system control unit 50 receives the composite image generated by the HMD 300.

In step S707, the system control unit 50 stores the composite image received in step S706 in the recording medium 227.

In step S708, the system control unit 50 determines whether communication with the PC 310 has been disconnected. When it is determined that the communication with the PC 310 has been disconnected, the processing of this flowchart ends. When it is determined that the communication with the PC 310 has not been disconnected, the processing proceeds to step S702.

### Live-View Processing

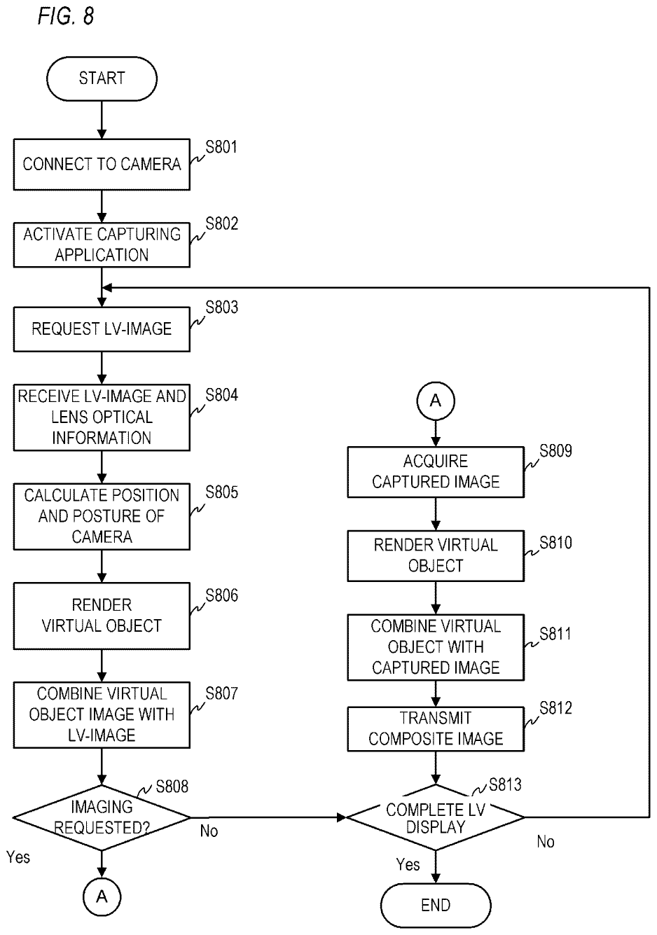

With reference to the flowchart of FIG. 8, live-view processing by the PC 310 in the first embodiment will be described. Note that, instead of the PC 310, the HMD 300 (HMD control unit 301) may execute all or part of the processing of this flowchart.

In step S801, the control unit 311 controls the communication unit 314 to connect to the camera 100 so that communication with the camera 100 becomes possible.

In step S802, the control unit 311 activates a capturing application. A UI (user interface) for the activated capturing application is displayed on the image display unit 303.

In step S803, the control unit 311 requests the camera 100 to acquire a live-view image.

In step S804, the control unit 311 receives the live-view image and the lens optical information from the camera 100.

In step S805, the control unit 311 calculates the position and posture (i.e., position and posture information) of the camera 100 on the basis of the live-view image and the lens optical information. For example, simultaneous localization and mapping (SLAM) can be used to calculate the position and posture. Note that the control unit 311 may calculate the distance from the imaging unit 302 by triangulation based on stereo matching using two live-view images acquired with the imaging unit 302. In this manner, the control unit 311 may calculate (or detect) the position and posture of the camera 100. Furthermore, the control unit 311 may use, as the posture information of the camera 100, the posture information acquired with the posture detection unit 222 within the camera 100.

In step S806, the control unit 311 renders an object in the virtual space displayed on the HMD 300 on the basis of the position and posture of the camera 100 so that the object appears as viewed from the camera 100.

In step S807, the control unit 311 combines the object in the virtual space displayed on the HMD 300 with the live-view image on the basis of the rendering result in step S806. In this manner, the control unit 311 generates a LV composite image. The control unit 311 then draws the LV composite image in the window of the capturing application.

In step S808, the control unit 311 determines whether imaging has been requested (i.e., imaging has been requested by the user operating the capturing application or by the user operating the camera 100). When it is determined that imaging has been requested, the processing proceeds to step S809. When it is determined that imaging has not been requested, the processing proceeds to step S813.

In step S809, the control unit 311 receives a captured image from the camera 100.

In step S810, the control unit 311 renders the object in the virtual space displayed on the HMD 300 on the basis of the position and posture of the camera 100 so that the object appears as viewed from the camera 100.

In step S811, the control unit 311 combines the object in the virtual space displayed on the HMD 300 with the captured image on the basis of the rendering result in step S810. In this manner, the control unit 311 generates a composite image.

In step S812, the control unit 311 transmits the composite image generated in step S811 to the camera 100.

In step S813, the control unit 311 determines whether to complete the live-view display (i.e., the display of the live-view image). When it is determined that the live-view display is completed, the processing of this flowchart ends. When it is determined that the live-view display is not completed, the processing proceeds to step S803.

### UI Display Processing

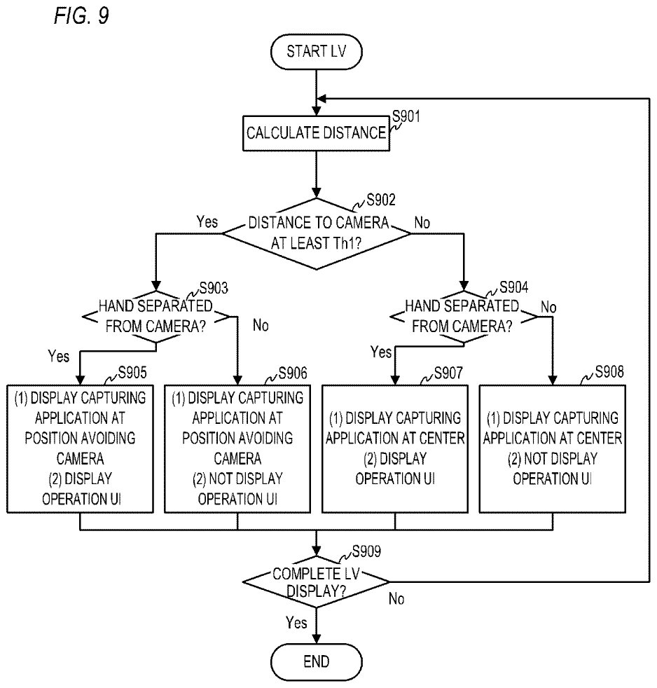

With reference to the flowchart of FIG. 9, UI display processing during live-view by the PC 310 according to the first embodiment will be described. Note that, instead of the PC 310, the HMD 300 (HMD control unit 301) may execute all or part of the processing of this flowchart.

In step S901, the control unit 311 calculates the distance between the HMD 300 (i.e., the user's head) and the camera 100 on the basis of images acquired with the imaging unit 302 (i.e., images obtained by capturing space from a user's point of view). For example, the control unit 311 executes SLAM calculation on the basis of the images to calculate the position and posture of the HMD 300. Then, the control unit 311 calculates the distance between the HMD 300 and the camera 100 on the basis of both the position and posture of the HMD 300 and the position and posture of the camera 100 calculated in step S805. The control unit 311 may use the distance information calculated in step S805 as the distance information between the HMD 300 and the camera 100. Note that when the processing of step S901 ends, the processing may proceed to step S903 instead of the step S902.

In step S902, the control unit 311 determines whether the distance between the camera 100 and the HMD 300 (i.e., the user's head) is at least a threshold Th1. When it is determined that the distance between the camera 100 and the HMD 300 is at least the threshold Th1, the processing proceeds to step S903. When it is determined that the distance between the camera 100 and the HMD 300 is less than the threshold Th1 (i.e., not more than a specific threshold), the processing proceeds to step S904.

In step S903, the control unit 311 determines whether the user's hand is separated from the camera 100 (or whether the distance between the user's hand and the camera 100 is less than a specific value) on the basis of the images acquired with the imaging unit 302. When it is determined that the user's hand is separated from the camera 100 (i.e., the hand is not gripping the camera 100), the processing proceeds to step S905. When it is determined that the user's hand is not separated from the camera 100 (i.e., the hand is gripping the camera 100), the processing proceeds to step S906.

In step S904, the control unit 311 determines whether the user's hand is separated from the camera 100 on the basis of the images acquired with the imaging unit 302. When it is determined that the user's hand is separated from the camera 100 (i.e., the hand is not gripping the camera 100), the processing proceeds to step S907. When it is determined that the user's hand is not separated from the camera 100 (i.e., the hand is gripping the camera 100), the processing proceeds to step S908.

In each of steps S905 to S908 below, processing is performed to generate a composite image in which an image is combined with the capturing application 1001 (i.e., the image captured with the camera 100) and to display the composite image on the image display unit 303.

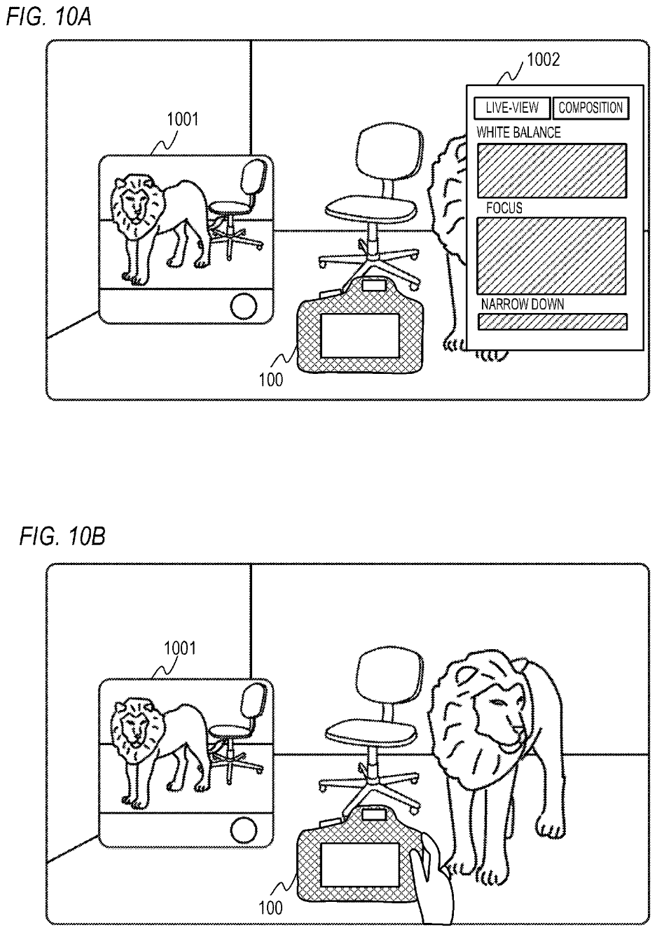

In step S905, the control unit 311 generates, as illustrated in FIG. 10A, a composite image in which the capturing application 1001 is arranged at a position that does not overlap the camera 100 in an image obtained by capturing the MR space from the user's point of view (i.e., the point of view of the HMD 300). Because the user is not gripping the camera 100 at this point, the likelihood of the user performing operations such as pressing a physical button on the camera 100 is low. Therefore, the control unit 311 may superimpose the capturing application 1001 on the camera 100 in the image obtained by capturing the MR space from the user's point of view (the point of view of the HMD 300). Furthermore, at this time, the control unit 311 also arranges an operation UI 1002 in the composite image to control the settings (capturing settings) of the camera 100 (i.e., brings the UI 1002 into a display state). The control unit 311 then displays the composite image on the image display unit 303. Note that at this time, the control unit 311 may estimate a range in which the fingers can reach on the basis of the positions and postures of the joint points of the fingers. If the capturing application 1001 is arranged outside this reachable range in the MR space, the control unit 311 may display the capturing application 1001 such that part of the camera 100 is superimposed on it. Furthermore, the control unit 311 may display the operation UI 1002 at a position within a prescribed distance from the hand separated from the camera 100 to facilitate the user operation.

In step S906, the control unit 311 generates, as illustrated in FIG. 10B, a composite image in which the capturing application 1001 is arranged at a position that does not overlap the camera 100 in an image obtained by capturing the MR space from the user's point of view. Furthermore, at this time, the control unit 311 does not arrange the operation UI 1002 in the composite image (i.e., brings the UI 1002 into a non-display state). The control unit 311 then displays the composite image on the image display unit 303. Note that at this time, the control unit 311 may estimate a range in which the fingers can reach on the basis of the positions and postures of the joint points of the fingers. If the capturing application 1001 is arranged outside this reachable range in the MR space, the control unit 311 may display the capturing application 1001 such that part of the camera 100 is superimposed on it.

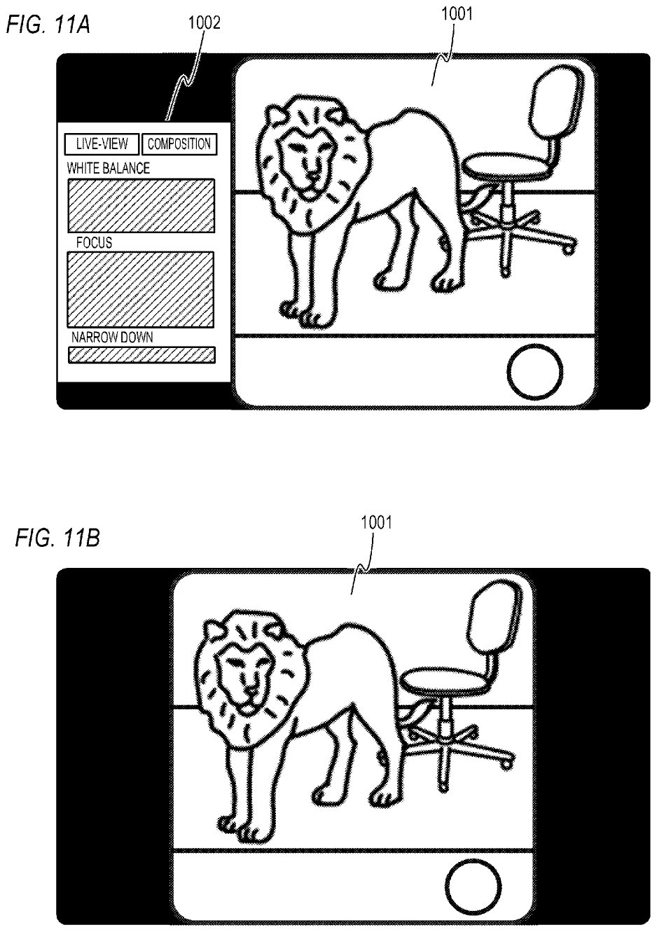

In step S907, the control unit 311 generates, as illustrated in FIG. 11A, a composite image in which the capturing application 1001 is arranged at the center of a background image (composite image) (i.e., at the center of the field of view of the HMD 300), and in which UI elements other than the capturing application 1001 are not displayed. Furthermore, the control unit 311 arranges the operation UI 1002 of the capturing application in the composite image (i.e., brings the UI 1002 into a display state). The control unit 311 then displays the composite image on the image display unit 303. Furthermore, the background image may be either an image obtained by capturing the MR space from the user's point of view or a black image. Instead of changing the background image to black, the control unit 311 may use an image obtained by applying at least one of defocus processing, monochrome processing, or luminance reduction processing to the image acquired with the imaging unit 302. At this time, the control unit 311 may arrange the capturing application 1001 at a position that is not necessarily at the exact center of the background image (composite image) but closer to the center in the composite image displayed on the image display unit 303 than in the cases of steps S905 and S906. In order to make it easier for the user to confirm the capturing application 1001, the control unit 311 may display (arrange) the capturing application 1001 in a larger size than in the cases of steps S905 and S906.

In step S908, the control unit 311 generates, as illustrated in FIG. 11B, a composite image in which the capturing application 1001 is arranged at the center of a background image (composite image) (i.e., at the center of the field of view of the HMD 300), and in which UI elements other than the capturing application 1001 are not displayed. Furthermore, the control unit 311 does not arrange the operation UI 1002 of the capturing application in the composite image (i.e., brings the UI 1002 into a non-display state). At this time, the control unit 311 may arrange the capturing application 1001 at a position that is not necessarily at the exact center of the background image (composite image) but closer to the center in the composite image displayed on the image display unit 303 than in the cases of steps S905 and S906. The control unit 311 may also display (arrange) the capturing application 1001 in a larger size than in the cases of steps S905 and S906. Furthermore, the background image may be either an image obtained by capturing the MR space from the user's point of view or a black image.

In step S909, the control unit 311 determines whether to complete the live-view display (LV display). When it is determined that the live-view display is completed, the processing of the this flowchart ends. When it is determined that the live-view display is not completed, the processing proceeds to step S901.

As described above, the position at which the capturing application 1001 is displayed is switched according to the distance between the camera 100 and the HMD 300. More specifically, when the distance between the camera 100 and the HMD 300 is small, the proportion occupied by the camera 100 in an image obtained by capturing the MR space from the user's point of view increases, reducing the need to view that image. Therefore, in such a case, it can be assumed that the user wants to refer to the capturing application 1001, and thus the capturing application 1001 is arranged at the center of the composite image. On the other hand, when the distance between the camera 100 and the HMD 300 is large, the proportion occupied by the camera 100 in an image obtained by capturing the MR space from the user's point of view is small, and thus the likelihood that the user wants to view the image is high. Therefore, in such a case, the capturing application 1001 is arranged at a position that does not overlap the camera 100, which is an important element in the image.

For example, when a user wearing an HMD grips an imaging device to perform imaging, the user may adopt a style of holding the imaging device up with both hands and looking through the viewfinder. This style has the advantages of “being able to perform imaging at almost the same position as one's eyes” and “being able to tuck in one's elbows and hold the camera firmly to stably perform imaging”. For this reason, this style is expected to be effective even when the user is wearing the goggles of the HMD. However, if this style is adopted, the imaging device occupies most of the image displayed on the HMD, and thus the user viewing the image cannot focus on imaging. In order to address this problem, according to this embodiment, it is possible to generate an image that enables the user to more focus on imaging when performing imaging processing while viewing a live-view image acquired with the camera 100 using the HMD 300.

Then, at least when the user's hand is not separated from the camera 100, the control unit 311 arranges the capturing application (i.e., an image captured with the camera 100) at a position that does not overlap the camera 100 in an image obtained by capturing the MR space from the user's point of view. As a result, when the user operates a physical button on the camera 100, interference from the capturing application can be prevented. That is, according to this embodiment, physical operations, such as user's button pressing, are facilitated while providing a virtual display.

### SECOND EMBODIMENT

In a second embodiment, an example is illustrated in which, when the user's line of sight is detected by the line-of-sight imaging unit 307, a UI is displayed only when it is determined that the camera 100 (external imaging device) is not present along the extension of the user's line of sight. According to this configuration, there is a likelihood that the user has released the hand to operate the touch panel of the camera 100, thereby preventing an unintended UI display.

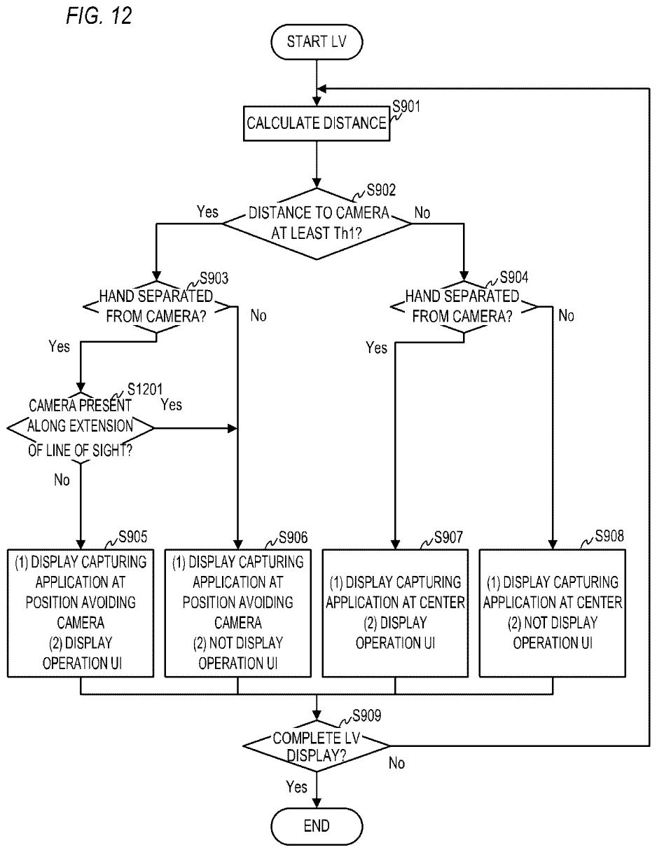

With reference to the flowchart of FIG. 12, UI display processing during live-view by the PC 310 according to the second embodiment will be described. Note that, instead of the PC 310, the HMD 300 (HMD control unit 301) may execute all or part of the processing of this flowchart. Note that steps S901 to S909 in the flowchart of FIG. 12 are the same as those in the first embodiment, and their description will be omitted.

The processing of step S1201 starts when it is determined in step S903 that the user's hand is separated from the camera 100. In step S1201, the control unit 311 acquires line-of-sight information of the user from the line-of-sight imaging unit 307. The control unit 311 then determines whether the camera 100 is positioned along the extension of the user' line of sight. When it is determined that the camera 100 is not positioned along the extension of the user' line of sight, the processing proceeds to step S905. When it is determined that the camera 100 is positioned along the extension of the user' line of sight, the processing proceeds to step S906.

Furthermore, in the above description, “processing proceeds to step S1 when A is at least B, and proceeds to step S2 when A is smaller (lower) than B” may be read as “processing proceeds to step S1 when A is larger (higher) than B, and proceeds to step S2 when A is not more than B.” Conversely, “processing proceeds to step S1 when A is larger (higher) than B, and proceeds to step S2 when A is not more than B” may be read as “processing proceeds to step S1 when A is at least B, and proceeds to S2 when A is smaller (lower) than B.” Therefore, unless contradiction arises, “at least A” may be read as “larger (higher, longer, or greater) than A,” and “not more than A” may be read as “smaller (lower, shorter, or less) than A.” Furthermore, “larger (higher, longer, greater) than A” may be read as “at least A,” and “smaller (lower, shorter, or less) than A” may be read as “not more than A.”

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

According to the present disclosure, physical operations, such as user's button pressing, are facilitated while providing a virtual display.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-021244, filed Feb. 13, 2025, which is hereby incorporated by reference herein in its entirety.

What is claimed is:

1. An information processing device communicably connected to an imaging device, the information processing device comprising:
one or more processors and/or circuitry configured to
execute first acquisition processing to acquire a first image in which a space including the imaging device is captured from a point of view of a user,
execute second acquisition processing to acquire a second image in which the space is captured with the imaging device, and
execute generation processing to generate a composite image in which the first image and the second image are combined, wherein,
in the generation processing, the composite image in which the second image is arranged so as not to overlap a region of the imaging device in the first image is generated in a case where the user holds the imaging device.

2. The information processing device according to claim 1, wherein, in the generation processing, the imaging device is positioned so as to overlap a region of the second image in a case where the second image is arranged at a position in a space illustrated by the composite image where a hand of the user does not reach.

3. The information processing device according to claim 1, wherein, in the generation processing, an operation UI (user interface) for controlling a setting of the imaging device is arranged in the composite image in a case where the user does not hold the imaging device.

4. The information processing device according to claim 1, wherein, in the generation processing, an operation UI (user interface) for controlling a setting of the imaging device is arranged in the composite image in a case where the user does not hold the imaging device and the imaging device is not positioned along an extension of a line of sight of the user.

5. The information processing device according to claim 1, wherein, in the generation processing, in a case where transitioning to a state in which the user does not hold the imaging device, the composite image in which an operation UI (user interface) for controlling a setting of the imaging device is arranged at a position within a prescribed distance from a hand separated from the imaging device is generated.

6. The information processing device according to claim 1, wherein, the one or more processors and/or circuitry is further configured to execute determination processing to determine whether the imaging device is gripped by a hand of the user on a basis of the first image.

7. The information processing device according to claim 1, wherein the second image includes a real-time image acquired from the imaging device.

8. The information processing device according to claim 1, wherein the second image includes a region for receiving an operation from the user.

9. The information processing device according to claim 1, wherein the imaging device is controlled on the basis of an instruction from the user.

10. The information processing device according to claim 1, wherein, in the generation processing, in a first case in which a distance between a head of the user and the imaging device is not more than a threshold, the second image is arranged closer to a center of the composite image than in a second case in which the distance is larger than the threshold.

11. The information processing device according to claim 10, wherein, the one or more processors and/or circuitry is further configured to execute third acquisition processing to acquire information of a distance between a head of the user and the imaging device.

12. The information processing device according to claim 11, wherein, in the third acquisition processing, the information of the distance between the head of the user and the imaging device is acquired on a basis of the first image.

13. The information processing device according to claim 10, wherein, in the generation processing, a black image is combined with the second image to generate the composite image in the first case.

14. The information processing device according to claim 10, wherein, in the generation processing, an image obtained by applying at least one of defocus processing, monochrome processing, or luminance reduction processing to the first image is combined with the second image to generate the composite image in the first case.

15. A method for controlling an information processing device communicably connected to an imaging device, the control method comprising:
executing first acquisition processing to acquire a first image in which a space including the imaging device is captured from a point of view of a user,
executing second acquisition processing to acquire a second image in which the space is captured with the imaging device, and
executing generation processing to generate a composite image in which the first image and the second image are combined, wherein,
in the generation processing, the composite image in which the second image is arranged so as not to overlap a region of the imaging device in the first image is generated in a case where the user holds the imaging device.

16. A non-transitory computer readable medium that stores a program, wherein the program causes a computer to execute a method for controlling an information processing device communicably connected to an imaging device, the control method comprising:
executing first acquisition processing to acquire a first image in which a space including the imaging device is captured from a point of view of a user,
executing second acquisition processing to acquire a second image in which the space is captured with the imaging device, and
executing generation processing to generate a composite image in which the first image and the second image are combined, wherein,
in the generation processing, the composite image in which the second image is arranged so as not to overlap a region of the imaging device in the first image is generated in a case where the user holds the imaging device.
